(19) United States
(12) Patent Application Publication
(10) Pub. No.: US 2019/0048662 A1
(43) Pub. Date: Feb. 14, 2019

(54) Extension Ladder Standoff Device

(71) Applicant: Timothy Melvin BEASSE, Comox (CA)

(72) Inventor: Timothy Melvin BEASSE, Comox (CA)

(21) Appl. No.: 16/049,632

(22) Filed: Jul. 30, 2018

Related U.S. Application Data
(60) Provisional application No. 62/538,391, filed on Jul. 28, 2017.

(51) Int. Cl. E06C 7/48; E06C 7/06; E06C 7/50

(52) U.S. Cl. CPC E06C 7/48; E06C 7/505; E06C 7/06

(57) ABSTRACT

A standoff device for an extension ladder for secure support against square or rounded surfaces. The device includes a pair of reinforced brackets with a thin, strong blade for reversible insertion into a wooden pole. The brackets are adjustable within the width of the ladder. Lag screw means are provided for securing the standoff device to the support surface. A universal attachment allows quick and easy attachment and removal of the standoff device for an extension ladder. The standoff device may be adjusted between use and storage positions.

### FIELD OF THE INVENTION

The present invention relates to industrial equipment and tools. In particular, the present invention relates to safety devices for ladders.

### BACKGROUND OF THE INVENTION

Ladders are a widely used tool. Whereas step ladders are designed to be stable, extension ladders rely for stability on the structure against which they are leaning. If the structure is a solid, strong, linear surface, the weight of the ladder and user usually will provide sufficient stability for use of the ladder.

However, if the structure's surface is not linear but rounded, as with an utility pole or tree, or if the structure includes devices such as eavestroughs along the support edge, it is desirable to provide a standoff device which may be attached temporarily to the extension ladder to permit secure, stable installation of the ladder against the structure.

While attempts have been made in the prior art to provide a standoff attachment for a ladder, these have been unstable, impractical, overly complex, or obstructing.

The device of the present invention addresses the shortcomings in the prior art by providing an extension ladder standoff device which is of simple construction, fits within the width of the ladder, is readily adjustable, and may be easily secured to the structure for optimum stability.

### BRIEF DESCRIPTION OF THE DRAWINGS

A detailed description of the preferred embodiment is provided below by way of example only and with reference to the following drawings in which:

FIG. 1 is a perspective view of one embodiment of the standoff device of the invention;

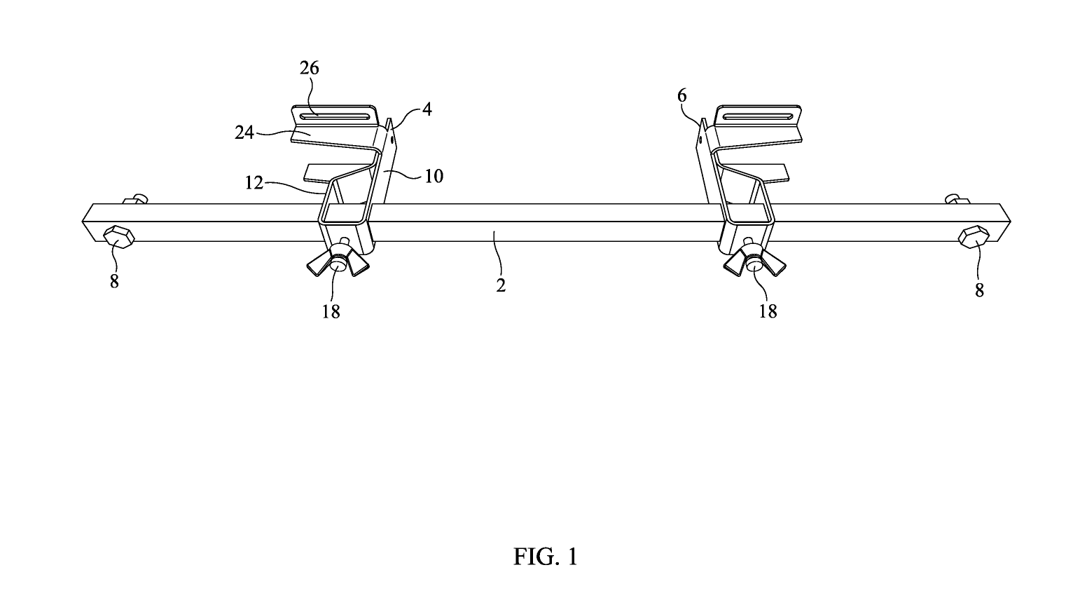

FIG. 2 is a perspective view of the standoff device of the invention mounted on an extension ladder and in use against a flat-sided post;

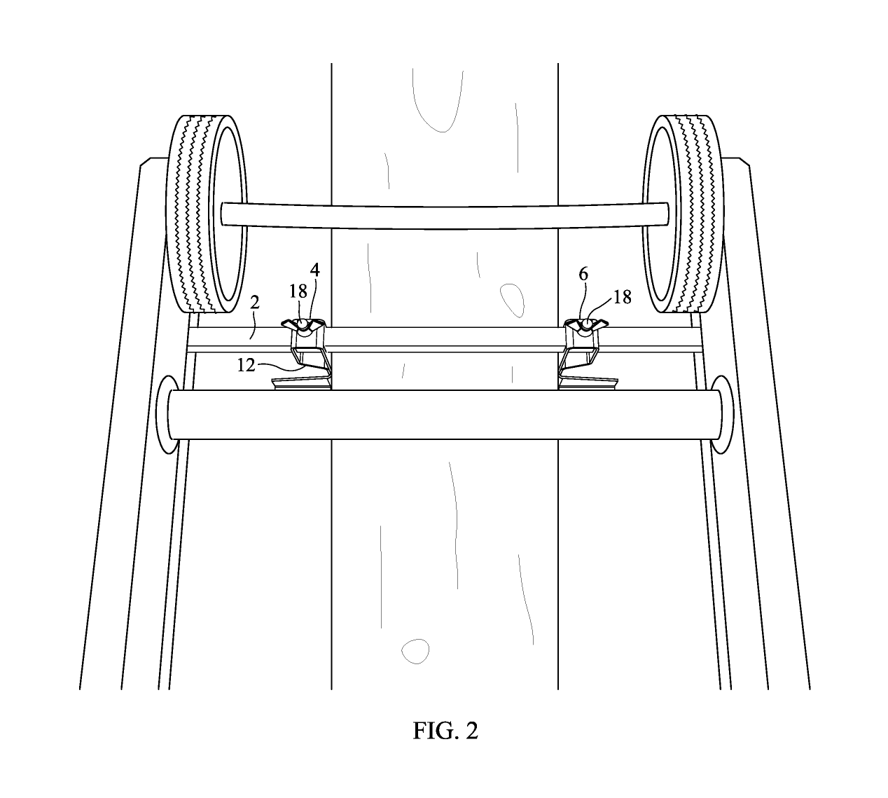

FIG. 3 is a side perspective view of the standoff device of the invention mounted on an extension ladder and in use against a rounded pole;

FIG. 4 is a front perspective view of the standoff device of the invention mounted on an extension ladder and in use against a rounded pole;

FIG. 5 is a perspective view of the standoff device of the invention mounted on an extension ladder showing lag screws securing the device to a rounded pole;

FIG. 6 is lower perspective view of the standoff device of the invention in use against a rounded pole;

FIG. 7 is a perspective view of another embodiment of the invention in an in-use position showing a universal mounting system for reversible attachment to an extension ladder; and

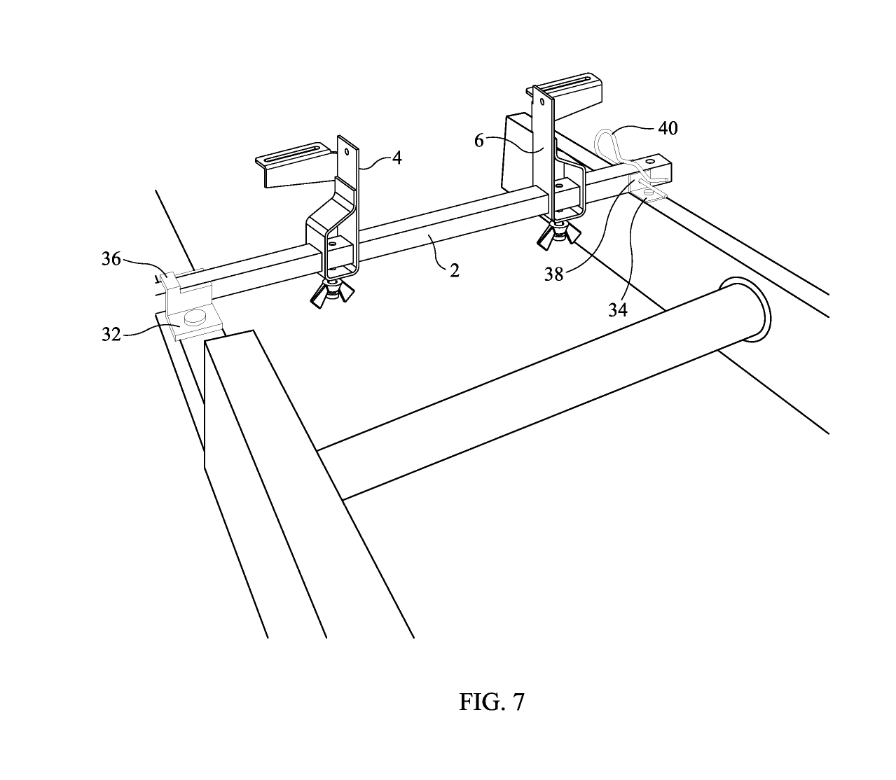

FIG. 8 is perspective view of the embodiment of FIG. 7 depicting the standoff device in position for storage and transportation.

Selected embodiments of the invention are illustrated in the drawings by way of citations in the text. It is to be expressly understood that the description and drawings are only for the purpose of illustration and as an aid to further clarify the descriptive text of the present invention and are not intended to limit the parameters and potential applications of the invention.

### DESCRIPTION OF THE INVENTION

As depicted in the figures, there is provided an extension ladder standoff device comprising a crossbar 2 having a non-circular cross-section, a pair of brackets 4, 6 slidably mounted on the crossbar, and mounting means 8 for reversibly mounting the crossbar to an extension ladder.

Each bracket comprises a metal band 10 at the first end, the metal band forming a loop back upon itself at the second end, wherein the second end forms a hollow loop structure 12. The crossbar passes through aligned openings 14, 16 in the parallel portions of the loop in proximity to the second end of each bracket corresponding in size and shape to the cross-sectional area of the crossbar.

By forming a metal loop at the second end of each bracket, the device provides greater strength than prior art devices. Whereas a single metal band may be easily bent under the weight of a user, the metal loop of the bracket of the present invention provides much greater strength to prevent deformation of the bracket under a user's weight.

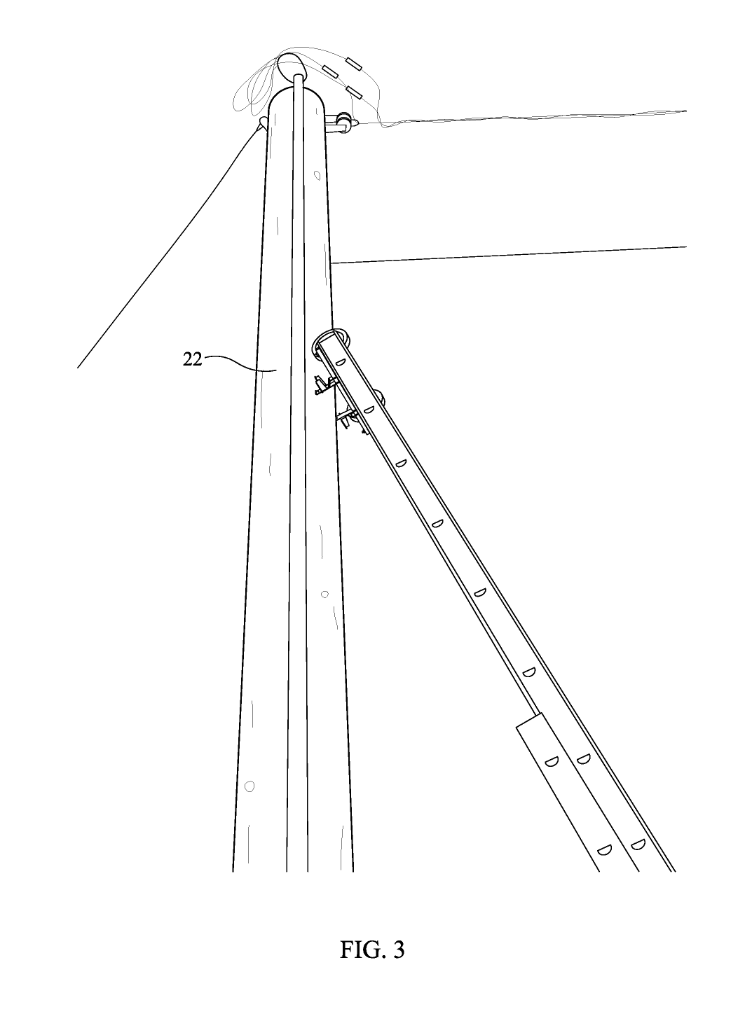

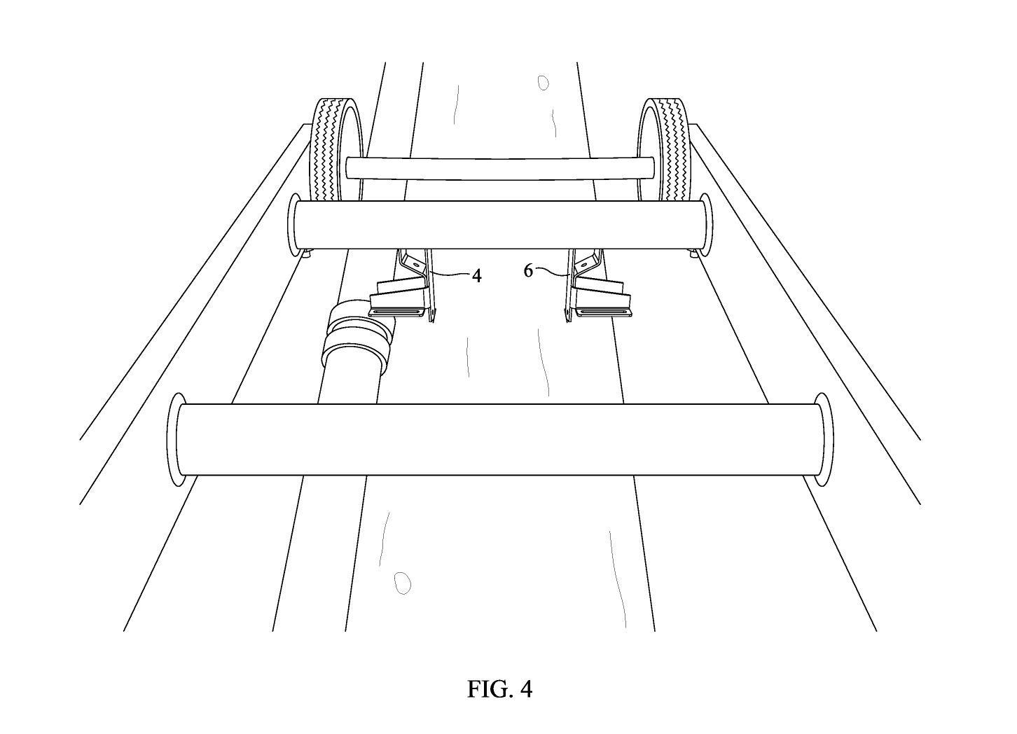

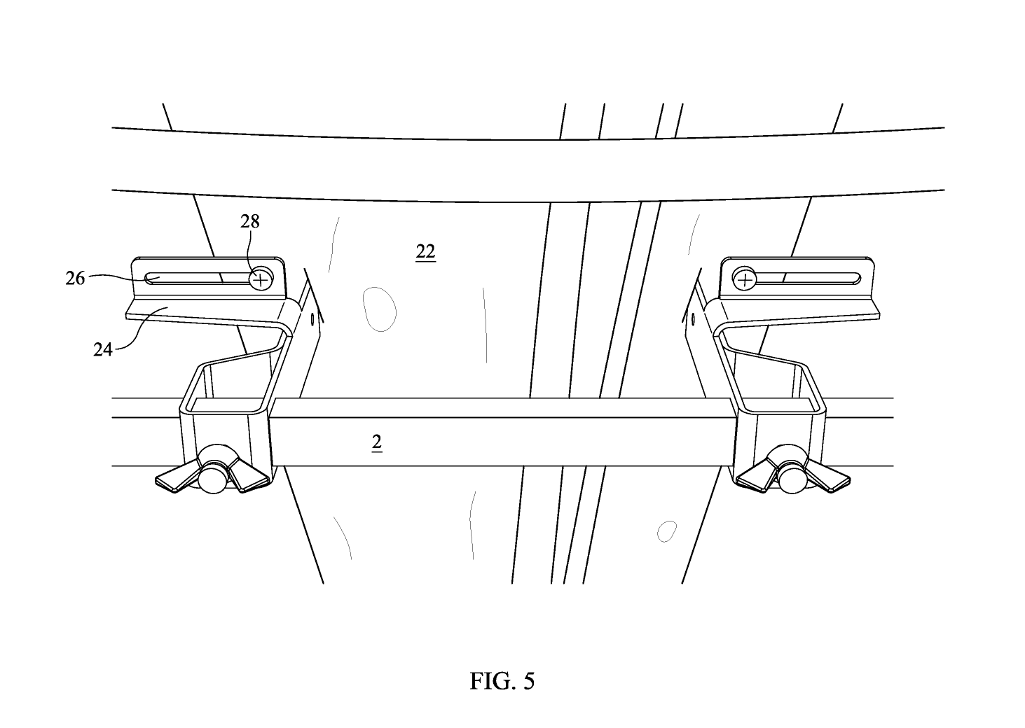

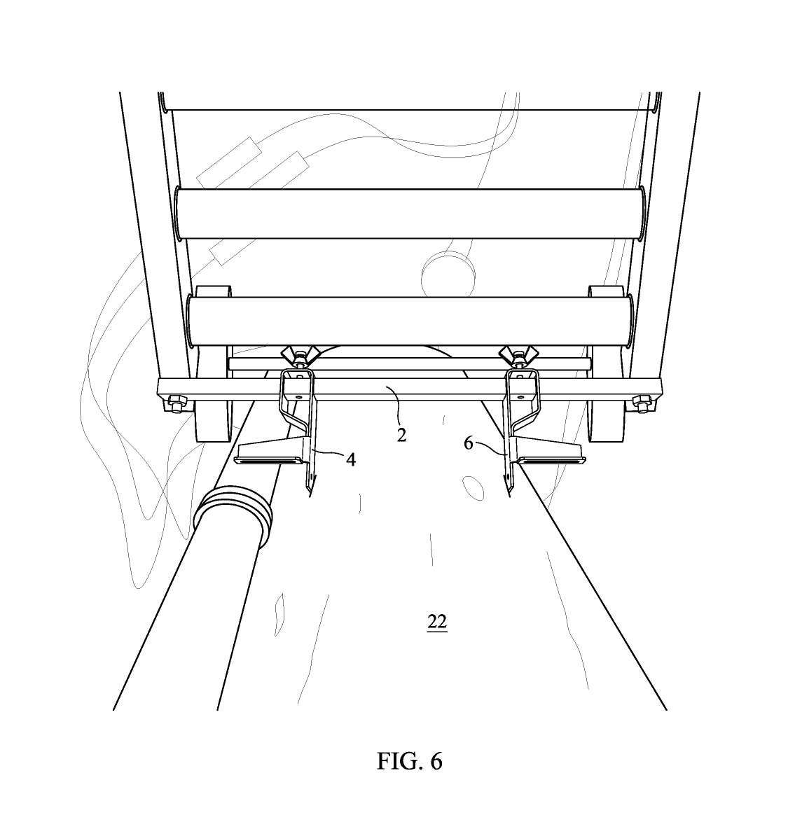

As may be seen in FIGS. 3-6, the single metal band at the first end of the bracket may function as a gripping blade for insertion of the end of the bracket into a material such as wood. This allows for a more secure attachment of the ladder to a rounded surface such as a utility pole.

An adjustable tightening bolt 18 may pass through a threaded opening in the second end of the bracket, perpendicular to the crossbar, to permit securing of the bracket to the crossbar.

The brackets may include securing means 20 for reversible securement of the device to the support structure 22. The securing means may comprise an opening 22 in the first end of each bracket to permit insertion of a fastener such as a screw, nail or bolt for securing the standoff device to the support structure.

According to one embodiment, there is provided on each bracket a perpendicular extension 24 having an elongated slot 26. A lag screw or other fastening means 28 may be used to secure the brackets to the supporting structure for increased safety. This is particularly important during prolonged work activity or activity that requires shifting of body weight or movement of tools while a user is on the ladder.

In a preferred embodiment, the crossbar is approximately 15 inches long, although other crossbar lengths are also within the scope of the invention. Preferably the width is equal to or smaller than the width of an extension ladder, thereby allowing the standoff device not to become an obstruction to use of the ladder, allowing full access by a user to a work site.

In a preferred embodiment, the brackets are parallel to each other and perpendicular to the crossbar. However, embodiments of the invention in which the brackets are non-parallel to each other and non-perpendicular to the crossbar are also within the scope of the invention. For example, the brackets may flare outwardly from the crossbar.

The brackets may be slidably adjusted along the length of the crossbar to accommodate support structures of differing dimensions and shapes. For example, the brackets may be adjusted to allow secure attachment to the flat sides of a square post, or they may be adjusted to allow gripping of the first end the metal band into the rounded wooden surface of a telephone pole.

The standoff device may be reversibly attached to one end of an extension ladder by attachment means, for example with bolts 30. According to a preferred embodiment, the attachment means may comprise a first brace 32 attachable in proximity to one end of one leg of the ladder, and a corresponding second brace 34 attachable in proximity to the corresponding end of the other leg of the ladder. The first brace preferably comprises a square enclosure 36 for secure insertion of a first end of the cross bar. The second brace preferably comprises a pair of perpendicular attachment brackets 38 with aligned holes corresponding to an opening through the second end of the crossbar to allow insertion therethrough of a bolt, cotter pin 40, or other easily removed securement device. The standoff device may be readily moved to another ladder if required.

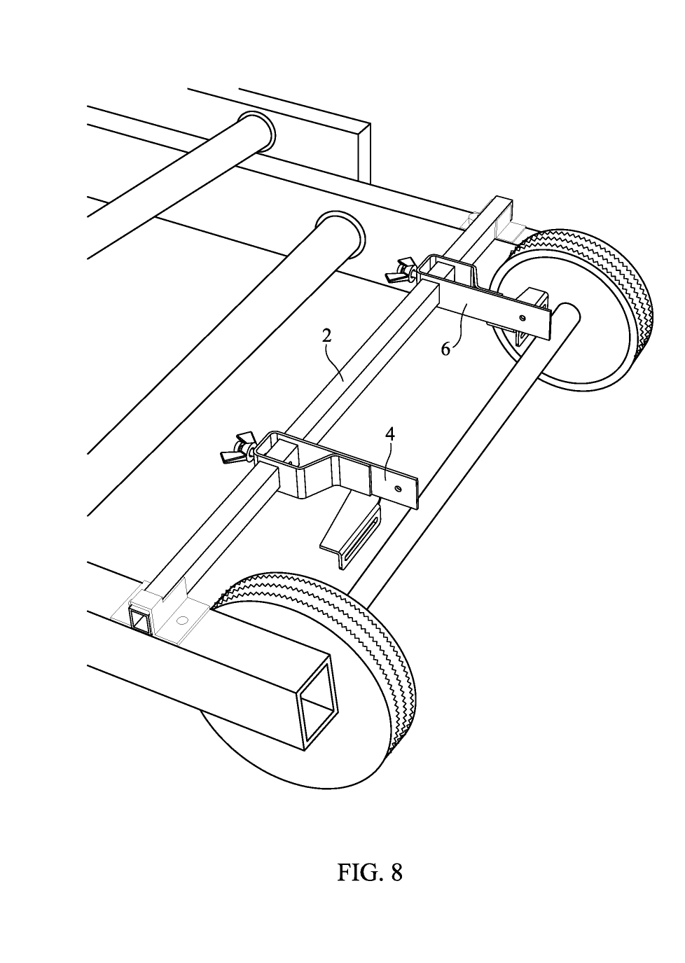

As may be seen in FIG. 8, the standoff device may be repositioned by rotating the crossbar 90 degrees to place the brackets between the ladder legs for storage and transportation. In an alternate embodiment, the standoff device may be manufactured integral to the extension ladder.

By raising the extension ladder away from the surface of the structure on which the ladder is mounted, the user has greater freedom of movement, and other tools may be more accessible as there is space for passage of cords, hoses, or other equipment between the structure and the ladder.

By adjusting the lateral position of one or both brackets, the standoff device may be adjusted to the most stable fit against a non-linear structure such as a utility pole.

The non-circular cross-section of the crossbar contributes to the secure attachment of the ladder to the support surface by preventing radial rotation of the brackets relative to the crossbar. The standoff device of the present invention preferably is attached to the ladder at a position which does not interfere with the presence of wheels and axle on the end of the extension ladder.

One clear advantage of the standoff device of the present invention is its small footprint and light weight. The device will not significantly add to the weight of a ladder, and will not interfere with storage, transport or use of the ladder. This provides greater functionality and safety for ladder users.

Another clear advantage is the ease of use of the device. The device is quick to install on a ladder and remove from the ladder. It may easily be adjusted between use and storage positions. It is easily adjusted in width to accommodate different sizes and materials of support structures. The device may be easily moved between several ladders, each equipped with attachment brackets if desired.

The standoff device of the present invention provides greater ladder stability by preventing lateral movement of the ladder relative to the structure. As the first ends of the brackets extend partially around a rounded structure such as a utility pole, the structure itself provides the resistance to lateral movement of the ladder.

It will be appreciated by those skilled in the art that other variations of the preferred embodiment may also be practiced without departing from the scope of the invention.

1. A standoff device for an extension ladder having left and right-side rails and a top rung extending between the left and right-side rails in proximity to a top end of the extension ladder, the standoff device comprising:
a. a crossbar having a non-circular cross-section;
b. mounting means for reversibly mounting the crossbar between the left and right-side rails of the extension ladder distal to the top rung of the extension ladder; and
c. left and right brackets adjustably connected perpendicular to the crossbar.

2. The standoff device of claim 1, wherein each bracket further comprises a metal band at a first end, the metal band forming a loop back upon itself at a second end, wherein the second end forms a hollow loop structure for passage therethrough of the crossbar.

3. The standoff device of claim 2 wherein each bracket further comprises a flat metal band at the first end.

4. The standoff device of claim 2 further comprising a threaded opening through the second end of each bracket and an adjustable tightening bolt for insertion through the threaded opening for fastening the bracket to a desired position on the crossbar.

5. The standoff device of claim 1 further comprising securing means for reversible securement of the device to a ladder support structure.

6. The standoff device of claim 5 wherein the securing means comprises an opening in the first end of each bracket and a corresponding fastener insertable through the opening for securing the standoff device to the ladder support structure.

7. The standoff device of claim 1, further comprising a perpendicular extension on each bracket, the perpendicular extension having an elongated slot for insertion therethrough of a screw for securing the standoff device to the ladder support structure.

8. The standoff device of claim 1 wherein the crossbar is between 12 and 18 inches long.

9. The standoff device of claim 1 wherein the brackets are parallel to each other.

10. The standoff device of claim 1 wherein the brackets are non-parallel.

11. The standoff device of claim 1, further comprising crossbar securing means for securing the crossbar to the extension ladder.

12. The standoff device of claim 11 wherein the securing means comprise each of a pair of braces attachable on opposing side rails for receiving opposing ends of the crossbar and a cotter pin for securing the crossbar within the braces.
